(19) United States
(12) Patent Application Publication
(10) Pub. No.: US 2016/0275170 A1
(43) Pub. Date: Sep. 22, 2016

(54) EVENT RECOMMENDATION SYSTEM AND METHOD

(71) Applicant: International Business Machines Corporation, Armonk, NY (US)

(72) Inventors: JOHN P. BUFE, Washington, DC (US); Krishna Kummamuru, Bangalore (IN); Lakshminarayanan Krishnamurthy, Round Rock, TX (US); Manojkumar Pal, Pune (IN)

(21) Appl. No.: 14/664,161

(22) Filed: Mar. 20, 2015

(51) Int. Cl. G06F 17/30; H04L 29/08

(52) U.S. Cl. CPC G06F 17/30598; H04L 67/306; G06F 17/30424

(57) ABSTRACT

A method, computer program product, and computer system for identifying data associated with an event. A recommendation is provided to at least the event based upon, at least in part, at least one of a character of the event determined based upon, at least in part, the data associated with the event, and a personality of a real-time crowd at the event determined based upon, at least in part, the data associated with the event.

### BACKGROUND

Every day in locations around the world, including urban areas, there may be numerous events (e.g., locations and other social venues) that people may choose to attend. Choosing which event to attend that may be the “best” experience for an individual may be difficult and time consuming. While some event recommendation systems may rely on such things as, e.g., location proximity, personal schedule, etc., these may be too generic for identifying the event that one may likely enjoy if attending.

### BRIEF SUMMARY OF DISCLOSURE

In one example implementation, a method, performed by one or more computing devices, may include but is not limited to identifying, by a computing device, data associated with an event. A recommendation may be provided to at least the event based upon, at least in part, at least one of a character of the event determined based upon, at least in part, the data associated with the event, and a personality of a real-time crowd at the event determined based upon, at least in part, the data associated with the event.

One or more of the following example features may be included. Providing the recommendation to at least the event may include clustering one or more events that are similar to the event based upon one or more preferences. Identifying the data associated with the event may include analyzing social media data. Determining the character of the event may include separating user reviews into a positive group of users and a negative group of users, generating one or more personality profiles for at least a portion of the positive group of users and the negative group of users, generating a group personality profile for the positive group of users and the negative group of users using the one or more personality profiles, and determining one or more distinguishing features between the positive group of users and the negative group of users. Determining the personality of the real-time crowd at the event may include generating a personality profile for at least a portion of users at the event, and generating a group personality profile from the personality profile. Clustering the one or more events may include determining a similarity metric for the event and the one or more events, wherein at least a portion of the one or more events above a similarity threshold may be clustered. The one or more preferences may include at least one of distance and transportation method.

In another example implementation, a computing system includes a processor and a memory configured to perform operations that may include but are not limited to identifying data associated with an event. A recommendation may be provided to at least the event based upon, at least in part, at least one of a character of the event determined based upon, at least in part, the data associated with the event, and a personality of a real-time crowd at the event determined based upon, at least in part, the data associated with the event.

One or more of the following example features may be included. Providing the recommendation to at least the event may include clustering one or more events that are similar to the event based upon one or more preferences. Identifying the data associated with the event may include analyzing social media data. Determining the character of the event may include separating user reviews into a positive group of users and a negative group of users, generating one or more personality profiles for at least a portion of the positive group of users and the negative group of users, generating a group personality profile for the positive group of users and the negative group of users using the one or more personality profiles, and determining one or more distinguishing features between the positive group of users and the negative group of users. Determining the personality of the real-time crowd at the event may include generating a personality profile for at least a portion of users at the event, and generating a group personality profile from the personality profile. Clustering the one or more events may include determining a similarity metric for the event and the one or more events, wherein at least a portion of the one or more events above a similarity threshold may be clustered. The one or more preferences may include at least one of distance and transportation method.

In another example implementation, a computer program product resides on a computer readable storage medium that has a plurality of instructions stored on it. When executed by a processor, the instructions cause the processor to perform operations that may include but are not limited to identifying data associated with an event. A recommendation may be provided to at least the event based upon, at least in part, at least one of a character of the event determined based upon, at least in part, the data associated with the event, and a personality of a real-time crowd at the event determined based upon, at least in part, the data associated with the event.

One or more of the following example features may be included. Providing the recommendation to at least the event may include clustering one or more events that are similar to the event based upon one or more preferences. Identifying the data associated with the event may include analyzing social media data. Determining the character of the event may include separating user reviews into a positive group of users and a negative group of users, generating one or more personality profiles for at least a portion of the positive group of users and the negative group of users, generating a group personality profile for the positive group of users and the negative group of users using the one or more personality profiles, and determining one or more distinguishing features between the positive group of users and the negative group of users. Determining the personality of the real-time crowd at the event may include generating a personality profile for at least a portion of users at the event, and generating a group personality profile from the personality profile. Clustering the one or more events may include determining a similarity metric for the event and the one or more events, wherein at least a portion of the one or more events above a similarity threshold may be clustered. The one or more preferences may include at least one of distance and transportation method.

The details of one or more example implementations are set forth in the accompanying drawings and the description below. Other features and advantages will become apparent from the description, the drawings, and the claims.

### BRIEF DESCRIPTION OF THE DRAWINGS

FIG. 1 is an example diagrammatic view of a recommendation process coupled to a distributed computing network according to one or more example implementations of the disclosure;

FIG. 2 is an example diagrammatic view of a client electronic device of FIG. 1 according to one or more example implementations of the disclosure;

FIG. 3 is an example flowchart of the recommendation process of FIG. 1 according to one or more example implementations of the disclosure;

FIG. 4 is an example diagrammatic view of a screen image displayed by the recommendation process of FIG. 1 according to one or more example implementations of the disclosure;

FIG. 5 is an example diagrammatic view of a screen image displayed by the recommendation process of FIG. 1 according to one or more example implementations of the disclosure; and

FIG. 6 is an example diagrammatic view of a screen image displayed by the recommendation process of FIG. 1 according to one or more example implementations of the disclosure.

Like reference symbols in the various drawings indicate like elements.

### DETAILED DESCRIPTION

### System Overview

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

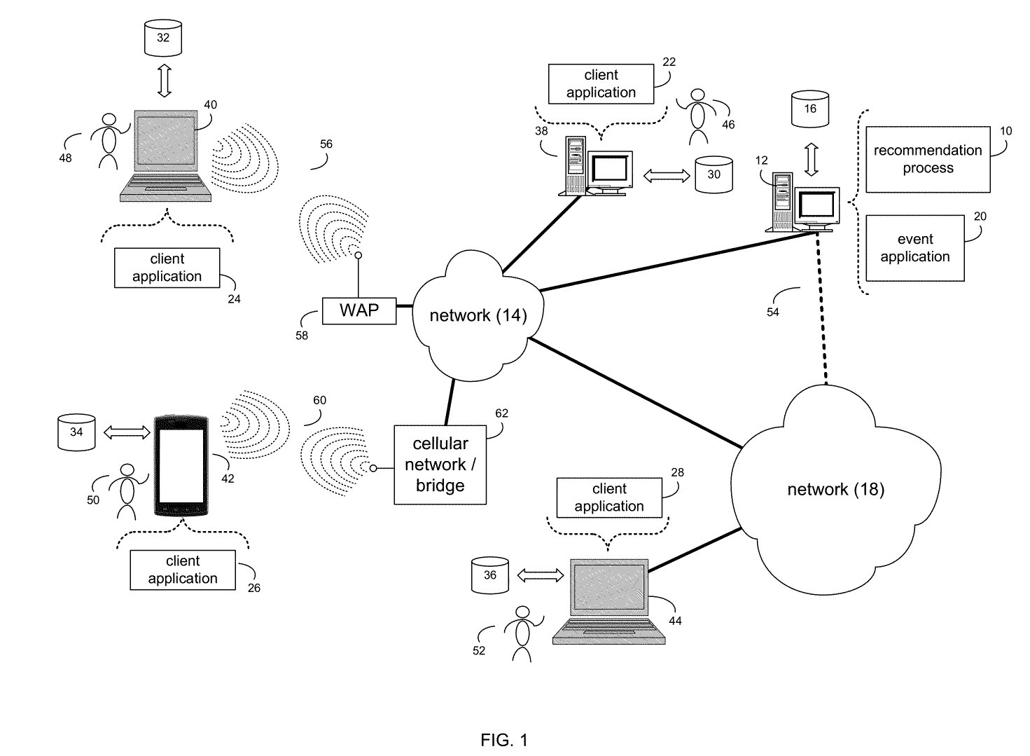

Referring now to FIG. 1, there is shown recommendation process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, recommendation process 10 may identify, by a computing device, data associated with an event. A recommendation may be provided to at least the event based upon, at least in part, at least one of a character of the event determined based upon, at least in part, the data associated with the event, and a personality of a real-time crowd at the event determined based upon, at least in part, the data associated with the event.

The instruction sets and subroutines of recommendation process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may include a data store, such as a database (e.g., relational database, object-oriented database, triplestore database, etc.) and may be located within any suitable memory location, such as storage device 16 coupled to computer 12. Any data described throughout the present disclosure may be stored in the data store. In some implementations, computer 12 may utilize a database management system such as, but not limited to, “My Structured Query Language” (MySQL®) in order to provide multi-user access to one or more databases, such as the above noted relational database. The data store may also be a custom database, such as, for example, a flat file database or an XML database. Any other form(s) of a data storage structure and/or organization may also be used. Recommendation process 10 may be a component of the data store, a stand alone application that interfaces with the above noted data store and/or an applet/application that is accessed via client applications 22, 24, 26, 28. The above noted data store may be, in whole or in part, distributed in a cloud computing topology. In this way, computer 12 and storage device 16 may refer to multiple devices, which may also be distributed throughout the network.

Computer 12 may execute an event application (e.g., event application 20), examples of which may include, but are not limited to, e.g., a calendar application, a scheduling application, an event organization application, a user review application, a social media application, or other application that allows for the planning, organization, or alerting of events. Recommendation process 10 and/or event application 20 may be accessed via client applications 22, 24, 26, 28. Recommendation process 10 may be a stand alone application, or may be an applet/application/script/extension that may interact with and/or be executed within event application 20, a component of event application 20, and/or one or more of client applications 22, 24, 26, 28. Event application 20 may be a stand alone application, or may be an applet/application/script/extension that may interact with and/or be executed within recommendation process 10, a component of recommendation process 10, and/or one or more of client applications 22, 24, 26, 28. One or more of client applications 22, 24, 26, 28 may be a stand alone application, or may be an applet/application/script/extension that may interact with and/or be executed within and/or be a component of recommendation process 10 and/or event application 20. Examples of client applications 22, 24, 26, 28 may include, but are not limited to, e.g., a calendar application, a scheduling application, an event organization application, a user review application, a social media application, or other application that allows for the planning, organization, or alerting of events, a standard and/or mobile web browser, an email client application, a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android′, Apple® iOS®, Mac® OS X®; Red Hat® Linux®, or a custom operating system.

One or more of client applications 22, 24, 26, 28 may be configured to effectuate some or all of the functionality of recommendation process 10 (and vice versa). Accordingly, recommendation process 10 may be a purely server-side application, a purely client-side application, or a hybrid server-side/client-side application that is cooperatively executed by one or more of client applications 22, 24, 26, 28 and/or recommendation process 10.

One or more of client applications 22, 24, 26, 28 may be configured to effectuate some or all of the functionality of event application 20 (and vice versa). Accordingly, event application 20 may be a purely server-side application, a purely client-side application, or a hybrid server-side/client-side application that is cooperatively executed by one or more of client applications 22, 24, 26, 28 and/or event application 20. As one or more of client applications 22, 24, 26, 28, recommendation process 10, and event application 20, taken singly or in any combination, may effectuate some or all of the same functionality, any description of effectuating such functionality via one or more of client applications 22, 24, 26, 28, recommendation process 10, event application 20, or combination thereof, and any described interaction(s) between one or more of client applications 22, 24, 26, 28, recommendation process 10, event application 20, or combination thereof to effectuate such functionality, should be taken as an example only and not to limit the scope of the disclosure.

Users 46, 48, 50, 52 may access computer 12 and recommendation process 10 (e.g., using one or more of client electronic devices 38, 40, 42, 44) directly through network 14 or through secondary network 18. Further, computer 12 may be connected to network 14 through secondary network 18, as illustrated with phantom link line 54. Recommendation process 10 may include one or more user interfaces, such as browsers and textual or graphical user interfaces, through which users 46, 48, 50, 52 may access recommendation process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

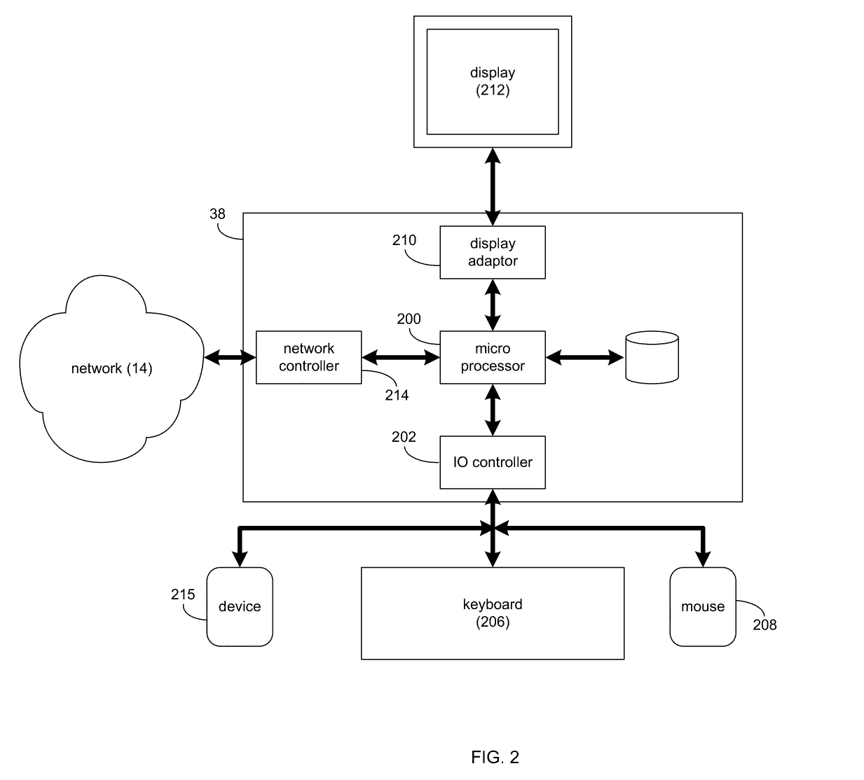

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, recommendation process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device(s) (e.g., storage device 30). An I/O controller (e.g., I/O controller 202) may be configured to couple microprocessor 200 with various devices, such as keyboard 206, pointing/selecting device (e.g., mouse 208), custom device (e.g., device 215), USB ports (not shown), and printer ports (not shown). A display adaptor (e.g., display adaptor 210) may be configured to couple display 212 (e.g., CRT or LCD monitor(s)) with microprocessor 200, while network controller/adaptor 214 (e.g., an Ethernet adaptor) may be configured to couple microprocessor 200 to the above-noted network 14 (e.g., the Internet or a local area network).

The Recommendation Process:

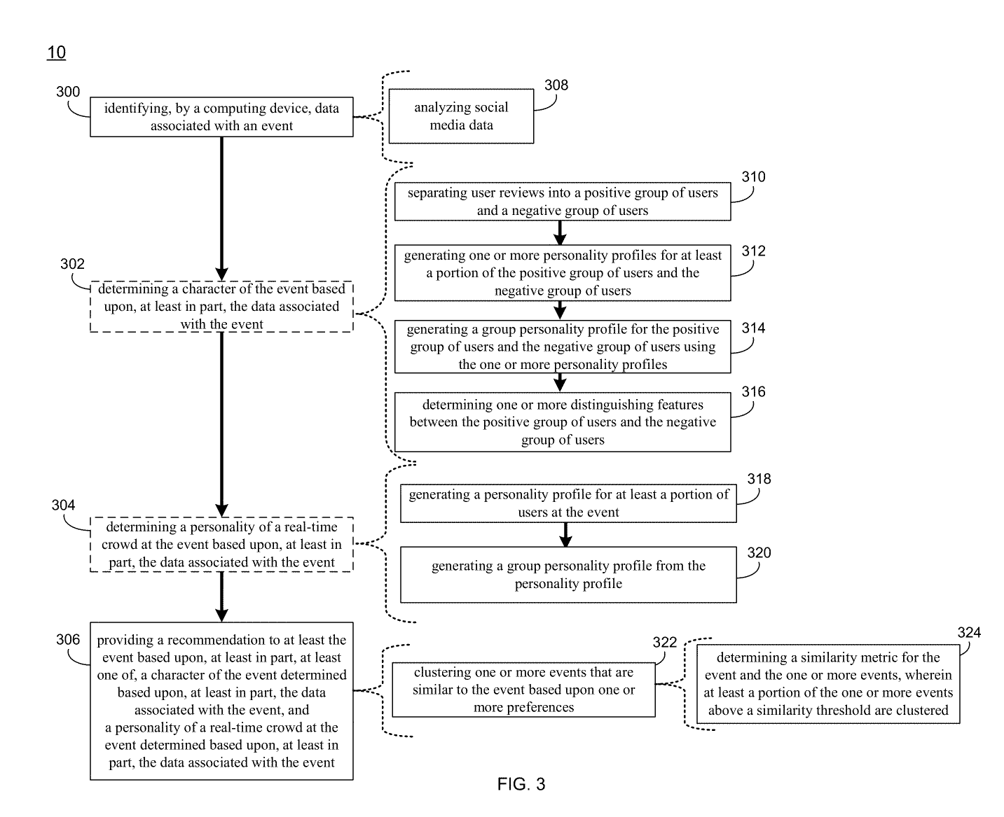

As discussed above and referring also at least to FIGS. 3-6, recommendation process 10 may identify 300, by a computing device, data associated with an event. Recommendation process 10 may provide 306 a recommendation to at least the event based upon, at least in part, at least one of a character of the event determined 302 based upon, at least in part, the data associated with the event, and a personality of a real-time crowd at the event determined 304 based upon, at least in part, the data associated with the event.

As noted above, every day in locations around the world, including urban areas, there may be numerous events (e.g., locations and other social venues) that people may choose to attend. Choosing which event to attend that may be the “best” experience for an individual may be difficult and time consuming. While some event recommendation systems may rely on such things as, e.g., location proximity, personal schedule, etc., these may be too generic for identifying the event that one may likely enjoy if attending. For example, current event recommendation systems may not take into account such things as, e.g., the “character” of an event, the rest of the crowd, and/or the ability to quickly move from one event to another.

Assume for example purposes only that a user (e.g., user 50) is looking for something to do on a Friday evening. In the example, user 50 may use, e.g., client electronic device 42 (e.g., via recommendation process 10, event application 20, client application 26, or combination thereof) to find an event to attend. In some implementations, recommendation process 10 may identify 300 data associated with an event. For example, the data may include the location/venue of the event, a time of when the event may occur, description of the event, social media and/or blog postings about the event, keywords associated with the event, or other information associated with the event. In some implementations, user 50 may enter keywords for searching for particular events.

In some implementations, identifying 300 the data associated with the event may include recommendation process 10 analyzing 308 social media data. For instance, and continuing with the above example, social media data may include, e.g., crowd-sourced reviews about businesses, events, etc. The social media data may be in the form of, e.g., a positive/negative star rating (e.g., 1-5 stars), positive or negative rating (e.g., thumbs up or thumbs down), written reviews/posts, social media profile information of the respective reviewing user (e.g., age, location, likes, political orientation, past event attendance, etc.). The social media data may be identified 300 and analyzed 308 from multiple social media sites, as well as blogs or other online media. It will be appreciated that other examples of social media data, as well as other examples of social media platforms, may be used without departing from the scope of the disclosure. As such, the examples of crowd-sourced reviews with the above-noted social media data should be taken as an example only and not to limit the scope of the disclosure.

In some implementations, recommendation process 10 may determine 302 a character of the event based upon, at least in part, the data associated with the event. For example, in some implementations, determining 302 the character of the event may include recommendation process 10 separating 310 user reviews into a positive group of users and a negative group of users, generating 312 one or more personality profiles for at least a portion of the positive group of users and the negative group of users, generating 314 a group personality profile for the positive group of users and the negative group of users using the one or more personality profiles, and determining 316 one or more distinguishing features between the positive group of users and the negative group of users.

For instance, assume for example purposes only that a particular event (e.g., Event X) occurs each week. For simplicity reasons, assume that four different users (e.g., User1, User2, User3, and User4) have previously attended Event X and have posted reviews on a social media based crowd-sourced review site. In the example, based upon, at least in part, each users' social media data (e.g., reviews, profile information, etc.) being analyzed 308, recommendation process 10 may determine that User 1 and User2 have posted positive reviews of Event X, and User3 and User4 have posted negative reviews of Event X. In the example, based at least upon their previous reviews of Event X, recommendation process 10 may separate 310 the user reviews into a positive group of users (e.g., User1 and User2) and a negative group of users (e.g., User3 and User4). In some implementations, recommendation process 10 may exclude users with “neutral” reviews (e.g., 3 out of 5 stars).

Continuing with the above example, recommendation process 10 may generate 312 one or more personality profiles for at least a portion of the positive group of users and the negative group of users. For instance, and based upon the above-noted reviews of Event X, for the positive group of users, recommendation process 10 may generate 312 a personality profile for User 1 and a personality profile for User2, and for the negative group of users, recommendation process 10 may generate 312 a personality profile for User3 and a personality profile for User4. An example technique for generating/determining personality profiles may be found in, e.g., System U: Computational Discovery of Personality Traits from Social Media for Individualized Experience, by Michelle Zhou, ACM RecSys 2014, Foster City, Silicon Valley, USA, 6^{th}-10^{th} Oct. 2014. In the example technique, the “big 5 personality traits” (e.g., openness, conscientiousness, extraversion, agreeableness, and neuroticism) may be used initially, and then individual traits that may fall under each umbrella trait may be chosen. Acronyms used by those skilled in the art to refer to the five traits collectively may include OCEAN, NEOAC, or CANOE. It will be appreciated that differing numbers of personality traits and differing examples of personality traits may be used without departing from the scope of the disclosure. It will also be appreciated that any technique for generating personality profiles may be used without departing from the scope of the disclosure. As such, the use of any of the “big 5 personality traits”, as well as the example technique to generate personality profiles in the above-noted System U: Computational Discovery of Personality Traits from Social Media for Individualized Experience, should be taken as an example only and not to limit the scope of the disclosure.

Continuing with the above example, for simplicity purposes, assume that only four personality traits are used for the personality profile (e.g., A, B, C, D). In the example, assume that A=openness, B=conscientiousness, C=extraversion, and D=agreeableness.

Thus, in the example, the personality profiles generated 312 for Event X may be User: Positive/Negative (A=openness, B=conscientiousness, C=extraversion, and D=agreeableness)

User1: Positive1: (0.5, 0.8, 0.1, 0.3)

User2: Positive2: (0.6, 0.9, 0.3, 0.3)

User3: Negative1: (0.7, 0.2, 0.6, 0.4)

User4: Negative2: (0.3, 0.1, 0.6, 0.1)

As will be appreciated, existing methods may be used by recommendation process 10 to provide these values by, e.g., analyzing unstructured text produced by the user. In some implementations, recommendation process 10 may use machine learning, which may generate each of the values based on the system's training

Continuing with the above example, recommendation process 10 may generate 314 a group personality profile for the positive group of users and the negative group of users using the one or more personality profiles. For instance, for the positive group of users, recommendation process 10 may generate 314 a group personality profile using the personality profile of User1 (e.g., Positive1: (0.5, 0.8, 0.1, 0.3)) and User2 (e.g., Positive2: (0.6, 0.9, 0.3, 0.3)), and for the negative group of users, recommendation process 10 may generate 314 a group personality profile with User3 (e.g., Negative1: (0.7, 0.2, 0.6, 0.4) and User4 (e.g., Negative2: (0.3, 0.1, 0.6, 0.1)).

Thus, in the example, the group personality profiles generated 314 for Event X may be: Group profiles (average/standard deviation, . . . )

Positive group: (0.55/0.05, 0.85/0.05, 0.2/0.1, 0.3/0)

Negative group: (0.5/0.2, 0.15/0.05, 0.6/0, 0.25/0.15)

Continuing with the above example, recommendation process 10 may determine 316 one or more distinguishing features between the positive group of users and the negative group of users. For instance, in the above example, personality traits A and D may be very close/overlap with each other with the standard deviations, and as such, recommendation process 10 may determine 316 that personality traits A and D are considered insignificant (e.g., non-distinct personality trait features) for Event X. It will be appreciated that the threshold closeness with each other with the standard deviations may vary and/or may be altered by user 50 (e.g., via recommendation process 10). In some implementations, non-distinct personality traits may be excluded from use when determining the character of the event and which events to recommend. Conversely, personality traits B and C may have clear separation with each other with the standard deviations, and as such, recommendation process 10 may determine 316 that personality traits B and C are distinguishing personality trait features and may be used to predict if a new user would likely be positive or negative. In the example, the “character of the event” may include personality traits B and C. That is, people with certain values for certain traits (e.g., traits B and C, may be more likely to enjoy Event X).

For instance, assume for example purposes only that if a new user, such as user 50, were to attend Event X, they may get a score between 0 and 1 (e.g., with 0 meaning do not recommend and with 1 meaning recommend strongly) based on the distinguishing personality traits B and C. In the example:
User 50: (0.1, 0.8, 0.3, 0.9), which may mean that because both personality traits B and C are closer to the positive group (e.g., (0.55/0.05, 0.85/0.05, 0.2/0.1, 0.3/0)), recommendation process 10 may predict a positive/recommendation for User 50 with Event X. In the example, recommendation process 10 may return 0.9 based upon the above-noted determination. It will be appreciated that any techniques using averaged/weighted distance metrics between the user and the significant values (e.g., based on both mean and standard deviation) may be used to return the number values without departing from the scope of the disclosure.

Further in the example:
New2: (0.1, 0.8, 0.6, 0.9), which may mean that because one trait is closer to positive and one is closer to negative, recommendation process 10 may determine mixed possibilities for New2, and may return 0.4.

Further in the example:
New3: (0.1, 0.5, 0.6, 0.9), which may mean that because one trait is between the two, but one is in the negative range, recommendation process 10 may predict a negative/do not recommend for New2 with Event X. In the example, recommendation process 10 may return 0.2 based upon the above-noted determination.

It will be appreciated that other techniques to determine 316 which distinguishing features/personality traits may be used for purposes of predicting if a new user would likely provide a positive review or a negative review without departing from the scope of the disclosure.

In some implementations, recommendation process 10 may determine 304 a personality of a real-time crowd at the event based upon, at least in part, the data associated with the event. For instance, assume for example purposes only that the people who are currently attending Event X may change over time. For example, the people attending Event X at, e.g., 4 PM may differ from the people attending Event X at, e.g., 11 PM. As will be appreciated, whether or not an event is recommended to be attended by a particular user may depend upon, e.g., the people currently at Event X, which may change over time. For example, Event X at 4 PM may involve mostly families for dinner with a suitable crowd for children, whereas Event X at 11 PM may involve a much younger and wilder crowd that may not be suitable for children. As such, recommendation process 10 may determine 304 a personality of a real-time crowd at the event.

For instance, recommendation process 10 may use at least a portion of the above-noted data associated with Event X, which may include who is/has been at Event X and during which times. In some implementations, this data may be identified 300 from, e.g., social media websites via “checking in” to locations, GPS within a client electronic device indicating that a user is at a particular location during a particular time, etc.

In some implementations, determining 304 the personality of the real-time crowd at the event may include recommendation process 10 generating 318 a personality profile for at least a portion of users at the event, and generating 320 a group personality profile from the personality profile. For instance, assume for example purposes only that the above-noted personality profiles and group personality profiles were generated 312/314 based upon the above-noted historical (e.g., prior) reviews of Event X. In the example, similarly to generating 312 the personality profiles and generating 314 the group personality profiles based upon historical reviews by people who were previously at Event X (and not currently at Event X), recommendation process 10 may similarly generate 318 a “real-time” personality profile based upon those people who are currently at the event based upon their respective historical (e.g., prior) reviews of Event X, and generate 320 a “real-time” group personality profile from their respective personality profiles.

For instance, assume for example purposes only that, using the same technique to generate 312/314 the personality/group personality profiles, recommendation process 10 may generate 318/320 the personality/group personality profiles for the real-time crowd group profile based upon those people who are currently at Event X at two different times (e.g., 4 PM and 11 PM). In the example, assume the following group personality profile is generated 320 (removing the standard deviation for simplicity purposes):

4 PM group: (0.5, 0.6, 0.1, 0.2)

11 PM group: (0.1, 0.9, 0.5, 0.9)

In some implementations, recommendation process 10 may provide 306 a recommendation to at least the event based upon, at least in part, at least one of a character of the event determined 302 based upon, at least in part, the data associated with the event, and a personality of a real-time crowd at the event determined 304 based upon, at least in part, the data associated with the event. For instance, using the above-noted group personality profile, when compared to the above-noted User 50 (0.1, 0.8, 0.3, 0.9) and New2 (0.1, 0.8, 0.6, 0.9) personality profile for 4 PM and 11 PM, assume for example purposes only that all features are used in the comparison resulting in:
User 50 at 4 PM: In the example, recommendation process 10 may return 0.6 (somewhat close) based upon the above-noted determination.
User 50 at 11 PM: In the example, recommendation process 10 may return 0.9 (very close) based upon the above-noted determination.
New2 at 4 PM: In the example, recommendation process 10 may return 0.5 based upon the above-noted determination.
New2 at 11 PM: In the example, recommendation process 10 may return 0.95 based upon the above-noted determination.

As such, in the above example, the final number returned may then be used by recommendation process 10 as a “relevance” score for Event X that may create a final recommendation score. For instance, user 50 at 4 PM may have a score of 0.6, which may indicate user 50 may be somewhat interested in attending Event X at 4 PM, but may be much more interested to attend Event X at 11 PM with a score of 0.9. Similarly, New2 at 4 PM may have a score of 0.5, which may indicate user 50 may be somewhat interested in attending Event X at 4 PM, but may be much more interested to attend Event X at 11 PM with a score of 0.95.

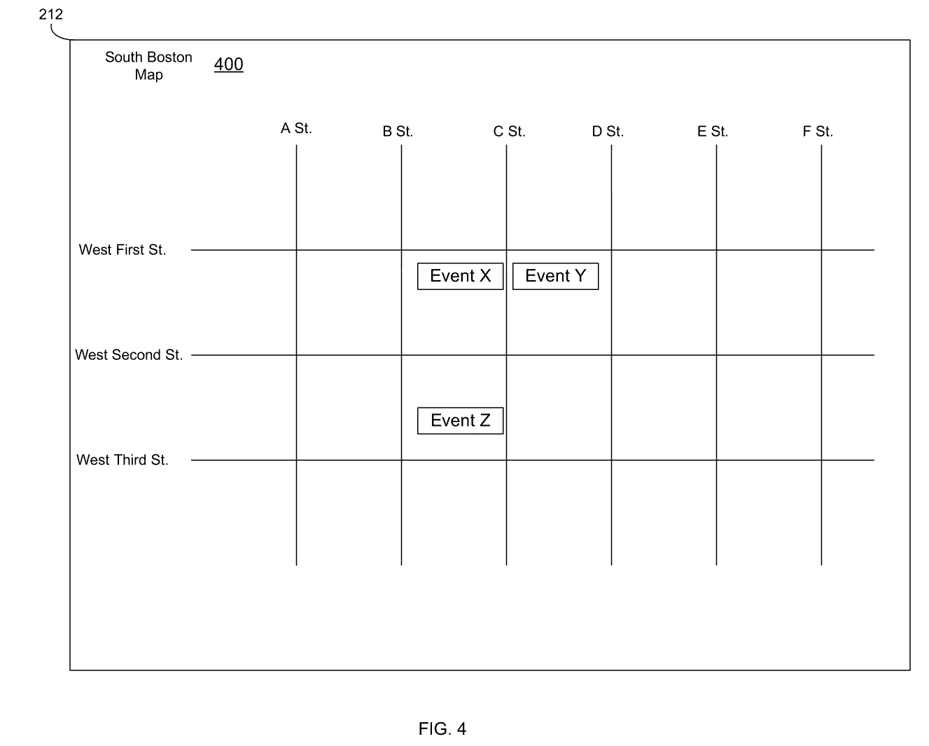

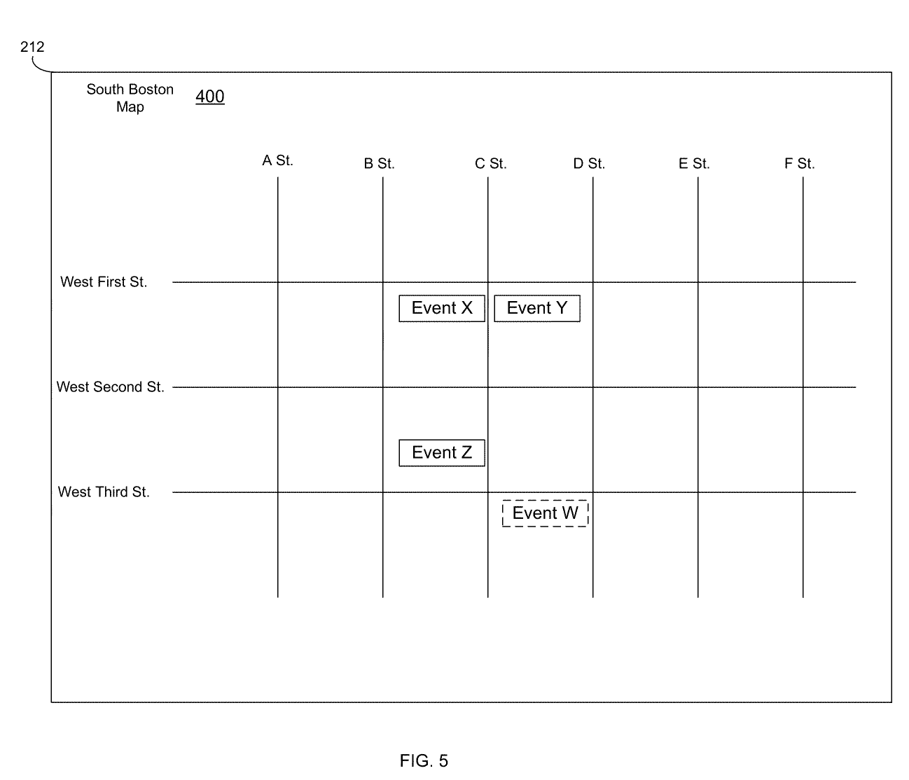

In some implementations, providing 306 the recommendation to at least the event may include recommendation process 10 clustering 322 one or more events that are similar to the event based upon one or more preferences. For instance, and referring at least to FIGS. 4 and 5, assume for example purposes only that user 50 is in South Boston, Mass. and that recommendation process 10 has enabled a graphical user interface rendering of a map 400 of South Boston, Mass. Further assume that there are three events currently ongoing (e.g., Event W, Event X, Event Y, and Event Z). As will be discussed in greater detail below, further assume that recommendation process 10 determines 324 that Event Y and Event Z are similar to Event X. In the example, due to the similarity of Event Y and Event Z to Event X, recommendation process 10 may cluster 322 Event X, Event Y, and Event Z on map 400 to show they are recommended events. In some implementations, because Event W was not determined 324 to be similar enough to Event X, recommendation process 10 may preclude rendering of Event Won map 400.

In some implementations, and referring at least to FIG. 5, recommendation process 10 may still render Event W on map 400, but may annotate Event W (e.g., with dashed lines or other annotations) to indicate that Event W is not considered similar to Event X. This may provide user 50 with the knowledge of Event W, in case, e.g., user 50 may still find Event W appealing to attend.

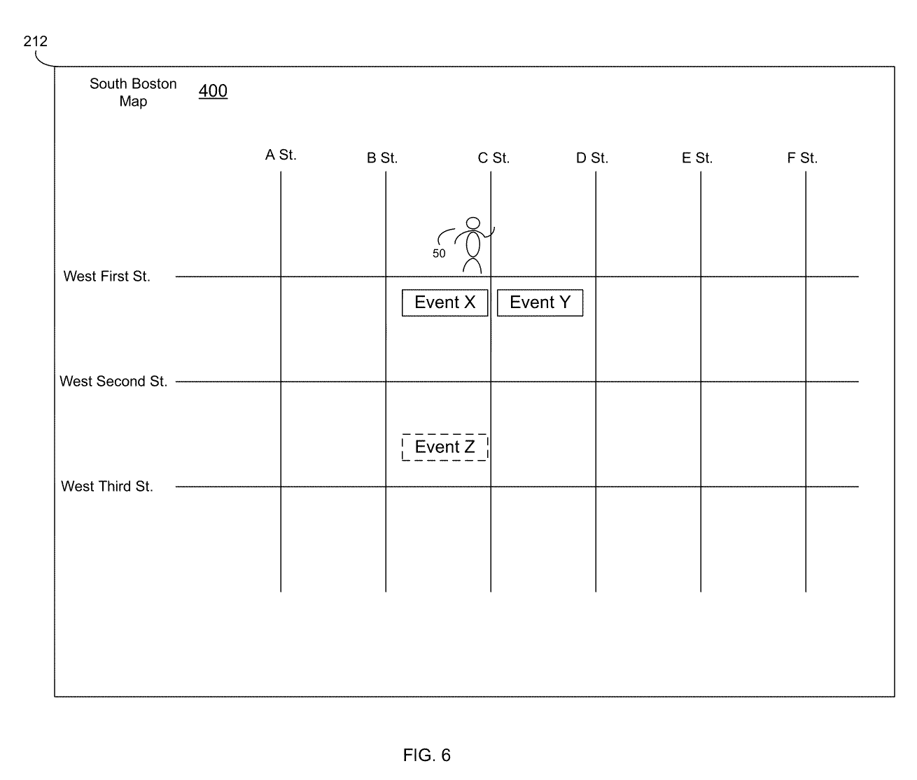

As noted above, providing 306 the recommendation to at least the event may include recommendation process 10 clustering 322 one or more events that are similar to the event based upon one or more preferences. In some implementations, and referring at least to FIG. 6, the one or more preferences may include at least one of distance and transportation method. For instance, assume for example purposes only that user 50 (e.g., via recommendation process 10) has entered a preference via a user interface (not shown) to filter similar events by distance from the current location of user 50. For example, assume that user 50 has entered the preference of only clustering 322 events within 0.5 miles of the current location of user 50. Further assume that Event X and Event Y are within the 0.5 mile threshold of user 50, and that Event Z is outside the 0.5 mile threshold of user 50. In the example, because Event X and Event Y are the only similar events within the 0.5 mile threshold of user 50's current location, those are the only two events clustered 322 with Event X. In some implementations, recommendation process 10 may still render Event Z on map 400, but may annotate Event Z (e.g., with dashed lines or other annotations) to indicate that Event Z is similar to Event X but outside the 0.5 mile threshold. This may provide user 50 with the knowledge of Event X, in case, e.g., user 50 may still find Event Z appealing to attend.

In some implementations, user 50 (e.g., via recommendation process 10) may enter a preference via a user interface (not shown) to filter similar events by distance from a particular event (e.g., Event X). For example, assume that user 50 has entered the preference of only clustering events within 0.5 miles of Event X. Further assume that Event Y is within the 0.5 mile threshold of Event X, and that Event Z is outside the 0.5 mile threshold of Event X. In the example, because Event Y is the only similar event within the 0.5 mile threshold of Event X, Event Y may be the only event clustered 322 with Event X. In some implementations, recommendation process 10 may still render Event Z on map 400, but may annotate Event Z (e.g., with dashed lines or other annotations) to indicate that Event Z is similar to Event X but outside the 0.5 mile threshold of Event X. This may provide user 50 with the knowledge of Event Z, in case, e.g., user 50 may still find Event Z appealing to attend. It will be appreciated that the particular event may be another predetermined event. For instance, similarly to the example above where user 50 has entered the preference of only clustering 322 events within 0.5 miles of Event X, user 50 may additionally/alternatively enter the preference of only clustering events within 0.5 miles of Event Y. This may be beneficial where, e.g., user 50 plans to go to other events after Event X, but does not necessarily want to travel more than 0.5 miles from Event X (or other events). Thus, in the example, recommendation process 10 may enable user 50 to pre-plan routes to multiple events (with preferences applying singly or to any combination of events) based upon the example preferences discussed throughout.

In some implementations, user 50 (e.g., via recommendation process 10) may enter a preference via a user interface (not shown) to filter similar events by transportation method to a particular event (e.g., Event X). For example, assume that user 50 has entered the preference of only clustering 322 events within 1.5 miles of public transit. Further assume that Event Y is within the 1.5 mile threshold of public transit (e.g., subway), and that Event Z is outside the 1.5 mile threshold of public transit. In the example, because Event Y is the only similar event within the 1.5 mile threshold to public transit, Event Y may be the only event clustered 322 with Event X. In some implementations, recommendation process 10 may still render Event Z on map 400, but may annotate Event Z (e.g., with dashed lines or other annotations) to indicate that Event Z is similar to Event X but outside the 1.5 mile threshold of public transit. This may provide user 50 with the knowledge of Event Z, in case, e.g., user 50 may still find Event Z appealing to attend. It will be appreciated that other example preferences (or any combination thereof) may be used without departing from the scope of the disclosure.

As noted above, clustering 322 the one or more events may include recommendation process 10 determining 324 a similarity metric for the event and the one or more events, wherein at least a portion of the one or more events above a similarity threshold may be clustered 322. For instance, user 50 (e.g., via recommendation process 10) may enter a preference via a user interface (not shown) to filter events by their similarity to Event X. For example, assume that user 50 has entered the preference of having a similarity metric value of 60%, and as such recommendation process 10 may only cluster 322 events at least 60% similar to (e.g., the character and/or group/real-time group personality profile or combination thereof) of Event X (e.g., based upon comparing the any combination of the above-noted character and/or group/real-time group personality profile of Event X with the group personality profiles of other events). Further assume that Event Y returns a 65% similarity metric value, and that Event Z returns a 59% similarity metric value. In the example, because Event Y is the only similar event above the 65% returned similarity metric value, Event Y may be the only event clustered 322 with Event X. In some implementations, recommendation process 10 may still render Event Z on map 400, but may annotate Event Z (e.g., with dashed lines or other annotations) to indicate that Event Z is an event but is outside the 60% similarity metric threshold value. This may provide user 50 with the knowledge of Event Z, in case, e.g., user 50 may still find Event Z appealing to attend. It will be appreciated that other threshold values may be used without departing from the scope of the disclosure.

As another example, user 50 (e.g., via recommendation process 10) may enter a preference via a user interface (not shown) to filter events by their similarity to user 50. For example, assume that user 50 has entered the preference of having a similarity metric value of 0.7, and as such recommendation process 10 may only clustering events above a 0.7 returned similarity value (based upon the above-noted personality v. group personality profiles). Further assume that Event Y returns a 0.8 similarity value, and that Event Z returns a 0.6 value. In the example, because Event Y is the only similar event above the 0.7 returned similarity value, Event Y may be the only event clustered 322 with Event X. In some implementations, recommendation process 10 may still render Event Z on map 400, but may annotate Event Z (e.g., with dashed lines or other annotations) to indicate that Event Z is an event but is outside the 0.7 similarity metric threshold. This may provide user 50 with the knowledge of Event Z, in case, e.g., user 50 may still find Event Z appealing to attend. It will be appreciated that other threshold values may be used without departing from the scope of the disclosure.

In some implementations, rather than relying predominantly on such things as, e.g., location proximity, personal schedule, etc., recommendation process 10 may provide 306 a more robust and accurate recommendation of available events and/or the association of the event to the user.

It will be appreciated that other techniques to provide 306 recommendations may be used without departing from the scope of the disclosure. For example, in some implementations, providing 306 the recommendation may include recommendation process 10 listing each recommended event ranked according to the recommendation level (e.g., higher recommended events ranked above lower recommended events). The list may come as a text message, email, shown on the above-noted map 400, etc. As such, the example of mapping events in clusters to provide 306 the recommendations should be taken as an example only.

In some implementations, the above-noted recommendation may be provided 306 based upon the character of the event without the personality of the real-time crowd. In some implementations, the above-noted recommendation may be provided 306 based upon the personality of the real-time crowd without the character of the event. As such, the use of providing the above-noted recommendation based upon both the character of the event and the personality of the real-time crowd at the event should be taken as an example only.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof

The corresponding structures, materials, acts, and equivalents of all means or step plus function elements that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of

1.-7. (canceled)

8. A computer program product residing on a computer readable storage medium having a plurality of instructions stored thereon which, when executed by a processor, cause the processor to perform operations comprising:
identifying data associated with an event; and
providing a recommendation to at least the event based upon, at least in part, at least one of,
a character of the event determined based upon, at least in part, the data associated with the event, and
a personality of a real-time crowd at the event determined based upon, at least in part, the data associated with the event.

9. The computer program product of claim 8 wherein providing the recommendation to at least the event includes clustering one or more events that are similar to the event based upon one or more preferences.

10. The computer program product of claim 8 wherein identifying the data associated with the event includes analyzing social media data.

11. The computer program product of claim 8 wherein determining the character of the event includes:
separating user reviews into a positive group of users and a negative group of users;
generating one or more personality profiles for at least a portion of the positive group of users and the negative group of users;
generating a group personality profile for the positive group of users and the negative group of users using the one or more personality profiles; and
determining one or more distinguishing features between the positive group of users and the negative group of users.

12. The computer program product of claim 8 wherein determining the personality of the real-time crowd at the event includes:
generating a personality profile for at least a portion of users at the event; and
generating a group personality profile from the personality profile.

13. The computer program product of claim 9 wherein clustering the one or more events includes determining a similarity metric for the event and the one or more events, wherein at least a portion of the one or more events above a similarity threshold are clustered.

14. The computer program product of claim 9 wherein the one or more preferences include at least one of distance and transportation method.

15. A computing system including a processor and a memory configured to perform operations comprising:
identifying data associated with an event; and
providing a recommendation to at least the event based upon, at least in part, at least one of,
a character of the event determined based upon, at least in part, the data associated with the event, and
a personality of a real-time crowd at the event determined based upon, at least in part, the data associated with the event.

16. The computing system of claim 15 wherein providing the recommendation to at least the event includes clustering one or more events that are similar to the event based upon one or more preferences.

17. The computing system of claim 15 wherein identifying the data associated with the event includes analyzing social media data.

18. The computing system of claim 15 wherein determining the character of the event includes:
separating user reviews into a positive group of users and a negative group of users;
generating one or more personality profiles for at least a portion of the positive group of users and the negative group of users;
generating a group personality profile for the positive group of users and the negative group of users using the one or more personality profiles; and
determining one or more distinguishing features between the positive group of users and the negative group of users.

19. The computing system of claim 15 wherein determining the personality of the real-time crowd at the event includes:
generating a personality profile for at least a portion of users at the event; and
generating a group personality profile from the personality profile.

20. The computing system of claim 16 wherein clustering the one or more events includes determining a similarity metric for the event and the one or more events, wherein at least a portion of the one or more events above a similarity threshold are clustered.
